(19) United States
(12) Patent Application Publication
(10) Pub. No.: US 2021/0031998 A1
(43) Pub. Date: Feb. 4, 2021

(54) Anti-Spoilage Packaging, Methods for Preparation, and Use Thereof

(71) Applicant: Produce-Safe Ltd., Sderot (IL)

(72) Inventors: Nery Nehoray, Kibbutz Ginegar (IL); Erez Yatzkhan, Kibbutz Kfar-Aza (IL)

(21) Appl. No.: 16/942,917

(22) Filed: Jul. 30, 2020

Related U.S. Application Data
(60) Provisional application No. 62/880,953, filed on Jul. 31, 2019.

(51) Int. Cl. B65D 65/40; B32B 27/08; B32B 27/30; B32B 27/32; B32B 27/20; B65D 81/26; B29B 7/90; B29C 48/00; B29C 48/21; B29C 48/10; B32B 1/08

(52) U.S. Cl. CPC B65D 65/40; B29K 2023/083; B32B 27/306; B32B 27/32; B32B 27/20; B65D 81/267; B29B 7/90; B29C 48/022; B29C 48/21; B29C 48/0018; B29C 48/10; B32B 1/08; B32B 2264/107; B32B 2553/00; B32B 27/08

(57) ABSTRACT

An anti-spoilage packaging material is composed of a film having one or more layers; and hygroscopic material embedded within at least one of the one or more layers. The hygroscopic material have an average particle size of 25 μm or less and is present in the one or more layers in amount from 1 wt. % to 20 wt. %. The packaging material maintains the equilibrium relative humidity (ERH) of packed goods between 95% and 100% and prevents spoilage of produce for a longer period than conventional packaging.

### CROSS-REFERENCE TO RELATED APPLICATION

This application is a non-provisional filing of, and claims priority to, U.S. Application 62/880,953 filed Jul. 31, 2019, which is incorporated herein in its entirety by reference.

### FIELD OF THE INVENTION

The present invention relates in general to the preservation of foodstuff. Specifically, the present invention relates to anti-spoilage food packaging material with hygroscopic materials for maintaining moisture within the foodstuff.

### BACKGROUND OF THE INVENTION

In recent years, much attention has been devoted to active packaging technologies for food preservation, while reducing the amount of food preservatives in the foodstuff itself.

Food preservation includes processes of treating and handling food to stop or slow down the process of spoilage and allow longer storage. Food spoilage may occur by physical, chemical, and microbial processes, and all such processes are affected by presence of water. Reducing free water content may curb many of these spoilage processes and especially those that are of microbial origin.

The contamination of food products with microorganisms, i.e. bacteria and fungi (yeasts and molds), presents a problem of global concern, since the growth and metabolism of microorganisms can cause serious food borne intoxications. Agricultural produce, commonly transported to far away destinations, is especially vulnerable to spoilage.

The presence of water facilitates microbial proliferation in foods. Many technologies are available for reducing food moisture content or to reduce availability of water for spoilage incidents. Water may be bound by solutes such as salts or sugar and/or by presence of other interacting components. One standard practice to reduce or eliminate water is the use of humidity absorbing packets, but these packets may be considered as foreign objects when introduced to food-containing packages and thus are generally banned for use in such packages.

Food moisture content in relation to food preservation is usually expressed by the term water activity (a_{w}) which is defined as the ratio of vapor pressure of water in a material to the vapor pressure of pure water at the same temperature. Relative humidity (RH) of air is defined as the ratio of the water vapor pressure of air to its saturation water vapor pressure at a given temperature. At equilibrium state, the a_{w} of a sample is equal to the RH of the air surrounding the sample in a sealed chamber. Multiplication of a_{w} by 100 gives the relative equilibrium humidity (REH) in percent.

Water activity a_{w} is sometime defined as “available water” in a system, and in the present context available for microbial, enzyme, and chemical activities which generally imply (food) spoilage. Most bacteria do not grow at a_{w} below 0.91 and most molds cease to grow at a_{w} below 0.8. Notably, a_{w} is temperature dependent, since temperature affects water binding, dissociation of water, and solubility of solutes in water.

Relative humidity (RH) is the ratio of the partial pressure of water vapor to the equilibrium vapor pressure of water at a given temperature. Accordingly, in foods kept in refrigerated storage, fluctuations of temperature and RH contribute to various undesired effects. Such fluctuations cause water vapor condensation within the package, powder agglomeration, and of course microbial growth at high RH. The generally known and recommended storage conditions for many food types and especially agricultural products usually include indication for temperature and RH.

Accordingly, attempts have been made to control the RH level in packages. For instance, WO2007/121909 describes films made of humidity regulating polymer composites containing salts as active hygroscopic substances wherein the preparation of these films focused on absorbing the humidity by NaCl.

An object of the present invention is to develop packaging materials and packages made therefrom, specifically food packages, that maintain a natural moisture of produce and impose environmental conditions unfavorable for microbial growth.

The object of the invention, as well as other objects will become apparent to those skilled in the art when the following detailed description of the invention is read in conjunction with the accompanying figures and claims.

### SUMMARY OF THE INVENTION

The following presents a simplified summary in order to provide a basic understanding of the disclosure. The summary is not an extensive overview of the disclosure and is not intended to identify key or critical elements or to delineate the scope of the disclosure. The following summary merely presents some concepts in a simplified form as a prelude to the more detailed description below.

The present invention provides an anti-spoilage packaging material comprising hygroscopic material embedded or incorporated therewith. The hygroscopic material may be, for example, a combination of sodium chloride, a preservative such as sulfate (SO₄), and at least one selected from magnesium (Mg) and calcium (Ca).

In some embodiments, the packaging material is in the form of a thin plastic film, optionally made of one or more distinct layers.

In some embodiments, one or more of the plastic film layers containing hygroscopic material have a foamed structure and a coarse surface. The coarse surface may have open crevices and fissures, which facilitate access of vapors to the hygroscopic material within the film layer(s).

In some embodiments, the hygroscopic material has an average particle size of 25 μm or less. The hygroscopic material is present in the packaging material in amount from 1 wt. % to 20 wt. %.

In certain embodiments, the anti-spoilage packaging material maintains the relative humidity (RH) within the sealed package to maintain the moisture within the food product. For example, the packaging material maintains an equilibrium relative humidity (ERH) of packed goods between 95% and 100%.

In one non-limiting aspect, the packaging material has at least three layers. An outer layer is composed of at least one selected from low density polyethylene, linear low density polyethylene, and medium density polyethylene. A core layer is composed of ethylene vinyl acetate, at least one foaming agent, hygroscopic material, and optionally linear low density polyethylene. An inner layer Is composed of low density polyethylene, low density polyethylene, foaming agent, and hygroscopic material. The hygroscopic material may be a combination of a salt, a preservative such as SO₄, and at least one of magnesium and calcium. The hygroscopic material has an average particle size of 25 μm or less and is present in the packaging material in amount from 1 wt. % to 20 wt. %.

Another aspect is directed to a method for preparation of a thin film packaging material having at least one polymer layer and hygroscopic material embedded within at least one of the at least one polymer layers. The hygroscopic material comprises a salt, SO₄, and at least one of magnesium and calcium The method steps include the steps of:

a) grinding the hygroscopic material to a particle size of 25 μm or less;

b) mixing the ground hygroscopic material with one or more polymers; and

c) forming the thin film packaging material, e.g. by film extrusion and/or foaming the film. The film may be laminated with other plastic film(s) of different composition or material, such as paper or metalized sheets.

### BRIEF DESCRIPTION OF THE FIGURES

The invention will be better understood upon reading the following non-limiting description of certain embodiments of the invention, reference being made to the accompanying figures, in which:

FIGS. 1A-1C are graphs showing water vapor (WV) absorption from a space enclosed in three film compositions, respectively.

FIG. 2 is a graph showing weight increase over time of a film packaging material due to water absorption when in contact with a food simulator.

FIG. 3 depicts a close up of packaging in accordance with one aspect of the invention.

FIGS. 4A and 4B depict stored figs packaged in conventional packaging and inventive packaging, respectively.

FIGS. 5A and 5B depict stored sweet potatoes packaged in conventional packaging and inventive packaging, respectively.

FIGS. 6A and 6B depict stored red table grapes packaged in conventional packaging and inventive packaging, respectively.

FIGS. 7A and 7B depict stored pomegranates packaged in conventional packaging and inventive packaging, respectively.

FIGS. 8A and 8B depict stored basil packaged in conventional packaging and inventive packaging, respectively.

### DETAILED DESCRIPTION OF THE INVENTION

Food packaging is intended to create a protecting barrier between the food and the environment, thereby preventing microbial contamination, controlling materials exchange (water vapor, oxygen, odorous substances, etc.), and/or protecting from light, dust, etc. Other attributes of food packaging are ensuring adequate labeling and providing user convenience, e.g. easy opening, re-closable lids, and/or dosing mechanisms. Packaging materials are commonly made of plastic films or of combinations of plastic films and other materials such as paper, cardboards sheets, and metalized sheets.

Innovative developments in the area of food packaging in the last few decades include “active” and “intelligent” packaging, based on deliberate interactions with the food or the food environment in a positive way to extend food shelf-life and maintain its quality. Many of the active packaging techniques incorporate substances that absorb gases, vapors, or volatiles such as oxygen, ethylene, moisture, carbon dioxide, and/or flavors/odors; some packaging incorporates antimicrobial agents or antioxidants; and other packaging uses agents for controlling effects of ultraviolet light. M.A.P. (Modified Atmosphere Packaging) solutions, currently offered to the market, are based on the dehydration of the produce.

The present invention relates to improved food packaging wherein hygroscopic material is incorporated into plastic films, in particular plastic films having a foamed structure. The present invention harnesses the natural moisture of the produce, re-creating the natural atmosphere. The food packaging of the present invention provides for prolonging storage and freight time of food items, conserving weight of food items, in particular produce, and protecting and/or improving the quality and appearance of produce.

Hygroscopic materials useful in the present invention are hydrophilic in nature and melt at temperatures above the normal processing temperatures of the plastic used for the plastic films. Plastics generally are hydrophobic in nature; thus, processes to incorporate the hygroscopic materials therein must provide not only stable compositions but also maintain material functionalities of the plastics such as flexibility, heat seal properties, transparency, mechanical strength, gas barrier properties, etc.

Thus attention is given to the compatibility of the different components and creation of a uniform and stable plastic mass. Plastic polymers with different and increased polarity properties may be selected to reduce the separation tendencies and help with humidity absorbing process. For example: suitable copolymers include, but are not limited to, ethylene vinyl acetate (EVA), ethylene methyl acrylate (EMA), poly(ethylene-co-methyl acrylic acid (EMMA-ionomer), ethyl acrylic acid (EAA-ionomer), ethylene ethyl acrylate (EEA), ethylene butyl acrylate (EBA), styrene ethylene butylenes styrene (SEBS) etc.

In certain embodiments, a film layer may include one or more of a polyolefin such as polyethylene (PE), PE copolymers, polypropylene (PP), or ethylene vinyl acetate (EVA). The polyolefin(s) may be joined by lamination technique with another polymer, for example, but not limited to, terephthalate (PET or PETE) and bi-oriented polypropylene (BOPP) polyamide (PA).

In certain embodiments, a film layer may include one of more of low density polyethylene (LDPE), linear low density polyethylene (LLDPE), and medium density polyethylene (MDPE.)

Suitable additives may be added to the polymer(s) for improving processing. In some embodiments, such additives include, but are not limited to, antioxidants, lubricants, and stabilizers. Such additives may prevent the melt of the polymer(s) and create agglomerates.

In a specific embodiment, the anti-spoilage packaging material of the invention is in the form of a single layered thin film, in which case a hygroscopic material is embedded or incorporated within the film during manufacture.

In another embodiment, the anti-spoilage packaging material of the invention is in the form of a multi-layered thin film, wherein each layer is distinct from one another. The hygroscopic material may be embedded or incorporated within one or more of the distinct layers during manufacture. In a specific embodiment, inner layer(s) that are facing or near the inner space of the package, are water-vapor accessible, such as to allow water and/or water vapors to pass from the inside of the package space towards layers containing the hygroscopic material Multi-layer films may have any number of layers such as two to six layers. Typically, multi-layer films have a three-layer structure.

In some embodiments containing multi-layered films, core layer(s) contain hygroscopic material. In some embodiments containing multi-layered films, the outer layer has barrier properties so that water vapor absorption happens from the inside of the package exclusively.

Any suitable process known in the art may be used to prepare the thin-films of the invention. Non-limiting examples of such processes are extrusion and co-extrusion by cast procedures or blown film procedures. Any of these films may be coated by extrusion coating techniques or any other techniques or laminated with films of different compositions.

In a specific embodiment, the hygroscopic material is incorporated in a coating material, which is applied by any known coating technology onto a thin-film sheet. Alternatively, the hygroscopic material is mixed together with one or more polymers or other material being used to prepare the thin film, thus enabling the production of a thin-film sheet embedded with the hygroscopic material. The hygroscopic material may be included in one or all and in any of the layers comprising the thin film sheet.

In certain embodiments, the thin film of the invention retains all of its important packaging material functionalities and properties such as mechanical strength, flexibility, heat seal properties, and certain permeability to various gases that would be present in the absence of the hygroscopic material.

In some embodiments, the packaging material of the invention may be fabricated in various packaging forms, such as bags or pouches, liners for packaging boxes such as cardboard boxes, bottom liners for tray packaging (i.e. to replace other absorbing pads), and lids for, e.g., trays and cups.

In some embodiments, the thin film is in a sheet form and is combined with or laminated on paper, cardboard, or metal sheets to form the packaging material.

Hygroscopicity is the ability of a substance to attract and hold water molecules from the surrounding environment. Known hygroscopic materials include, but are not limited to, salts, cellulose fibers (such as cotton and paper), sugar, caramel, honey, glycerol, ethanol, methanol, sulfuric acid, many fertilizer chemicals, silica, etc.

Accordingly, in certain embodiments, the hygroscopic material actively balances water and/or water vapors in the free space within the package and/or from the packed good(s) itself to maintain a “natural atmosphere” in order to maintain the moisture in the packed goods. For example, potatoes are packaged to maintain a natural moisture level of potatoes in the ground. The micro-environment within the packaging prevents or delays pathogen growth and/or microbial activity.

In specific embodiments, the hygroscopic material used in the thin film packaging material of the invention includes salts. Suitable salts include, but are not limited to, sodium chloride, potassium chloride, zinc chloride, sodium carbonate, potassium carbonate, potassium sulfate, potassium nitrate and/or calcium chloride. In certain aspects, the hygroscopic material is sodium chloride.

In specific embodiments, the hygroscopic material used in the thin film packaging material of the invention includes salt(s), a preservative such as a sulfate, and at least one of magnesium (Mg) and calcium (Ca). For example, the hygroscopic material is a combination of sodium chloride (NaCl), a sulfate (SO₄), and at least one of magnesium (Mg) and calcium (Ca). Generally, the sulfates, magnesium, and calcium are obtained in micronized form.

In other embodiments, other hygroscopic material or combinations thereof, which are edible and approved for consumption, can be used as the hygroscopic material, such as xylitol, sorbitol and other polyols.

Relative humidity (RH) is the ratio of the partial pressure of water vapor to the equilibrium vapor pressure of water at a given temperature. Relative humidity depends on temperature and the vapor pressure of the system of interest. Equilibrium relative humidity (ERH) is the RH of air in equilibrium with a sample. When placing a hygroscopic material in a confined space, it adsorbs water and water vapor from the surrounding air, as well as from any sample present therein. In certain embodiments, the ERH value depends on the water affinities and water holding capacities (WHC) of the packaging material and of the WHC of the hygroscopic materials, the packaged object and the ambient temperature.

Accordingly, in certain embodiments, the packaging material of the invention containing hygroscopic material maintains ERH of packed goods at levels of at least 95 wt. %, of at least 97 wt. %, or of at least 99 wt. %. In specific embodiments, the packaging material of the invention maintains ERH of packed goods at 95 wt. % to 100 wt. %

In certain embodiments, the hygroscopic functionality of the hygroscopic material within the packaging material of the invention begins as soon as the package is closed, and results in changes in the relative humidity (RH) in the free space within the packaging, which evolves into an equilibrium relative humidity (ERH). The ERH value obtained thereby may be slightly lower than the initial ERH value that existed immediately upon closure. In certain embodiments, the packaging material of the invention enables the desired ERH value of the packed goods to be maintained every time the package is hermetically closed. As such, the present invention provides a packaging material, which continuously maintains the ERH value of packed goods, whenever the package is hermetically closed, even after opening and reclosing.

The present invention provides a packaging material that prevents pathogen growth and/or microbial activity in packed goods, such as packed foodstuff, thereby extending shelf life, and improving the foodstuff's taste and durability. In addition, since the packaging material of the invention inhibits/reduces pathogen growth and/or microbial activity, it allows reducing the concentration of preservatives used to preserve packed foodstuff, thereby reducing costs and improving health.

In certain embodiments, the water vapors affinities and WHC of the packaging material of the invention can be manipulated to create ERH values within the package that discourage microbial contaminants proliferation and limit the occurrence of other biological processes. This deters spoilage of the packaged goods. ERH values that may be obtained and are of practical value to food preservation are at the range of 95 to 100%.

In certain embodiments, the anti-spoilage packaging material of the invention, due to the presence of the hygroscopic material, maintains a constant balance of relative humidity (RH), i.e. maintains constant RH, during storage, thereby prolonging safe storage and transport time. This feature is obtained by the equilibrium of absorbing and releasing water by the hygroscopic material, until the RH reaches a desired value, such as 95%-100% RH. Notably, temperature affects such absorption and release of water by the hygroscopic material.

In certain embodiments, the packaging materials and packages made therefrom or equipped therewith, have one or more of (i) the ability to maintain moisture of the products; (ii) reduced spoilage process; (iii) keeping the freshness; and (iv) no weight loss of the packed product. As a result, packaging using the anti-spoilage packaging materials or packages according to the invention enables extended storage and transport times, increases shelf life of fresh produce, and protects and improves the appearance of the produce.

The present invention further provides methods for the preparation of the anti-spoilage packaging material of the invention. Accordingly, in certain embodiments, the present invention provides a method for the preparation of a thin film packaging material comprising hygroscopic material embedded therein, including the step of: (a) grinding or milling the hygroscopic material or using any other suitable technique to bring the hygroscopic material to a particle size which is small enough to be integrated within the packaging material so as to form a smooth and homogeneous composition. The particle size may be 25 μm or less, 20 μm or less, 10 μm or less, or may vary from 1 to 25 μm, from 1 to 20 μm, from 1 to 10 μm. The process includes the steps of (b) mixing the milled hygroscopic material with the packaging material forming agents, and any other additives and processing aids necessary for forming the final packaging material, to create an homogenous composition; and (c) forming the thin film packaging material by any suitable technique.

In certain embodiments, the ground hygroscopic material provides an increased surface area, which increases their effective hygroscopic functionality, thereby reducing the amount of material needed for obtaining the desired results.

Aspects that may be considered when preparing the packaging material of the invention include the concentration of the hygroscopic material embedded within the polymer film; the desired film thickness; and the effect of the hygroscopic material on the physical and mechanical properties of the polymer being used. The present invention overcomes/avoids undesirable effects that may occur by incorporating the hygroscopic material into the thin-film sheets of packaging material. The packaging provides a level of humidity that keep the freshness of the goods and creates a growth-inhibiting environment for molds and bacteria.

The resulting films may be any suitable thickness that provides a suitable packaging film, typically 15 to 300 μm thick.

The hygroscopic material may be incorporated into the polymer matrix by any suitable manner such as hot melt-compounding in an extruder in the presence of various additives (e.g. polymers, processing aids, stabilizers, antioxidants, compatibilizers, dispersants, colorants, fillers, etc.).

In certain embodiments, the concentration of the hygroscopic material in the final thin film packaging material of the invention is from about 1 wt. % to about 20 wt. %; from about 1 wt. % to about 18 wt. %, 15 wt. %, 10 wt. %, 7 wt. % or 4 wt. %; from about 3 wt. % to about 20 wt. %, 18 wt. %, 15 wt. %, 10 wt. %, 7 wt. %, or 4 wt. %; from about 5 wt. % to about 20 wt. %, 18 wt. %, 15 wt. %, 10 wt. %, or 7 wt. %; from about 7 wt. % to about 20 wt. %, 18 wt. %, 15 wt. %, or 10 wt. %; or from about 10 wt. % to about 20 wt. %, 18 wt. %, or 15 wt. %.

In one particular embodiment, the hygroscopic material may include 90%-98% NaCl, 0.55%-1.5% calcium, 0.2%-2% magnesium, and 0.5%-5% SO₄.

In certain embodiments, the method of the invention further comprises forming a multi-layered thin film packaging material, suitable for packing any desired goods. The preparation should not damage the final packaging material packaging functionalities and properties such as strength, flexibility, heat-seal properties, etc.

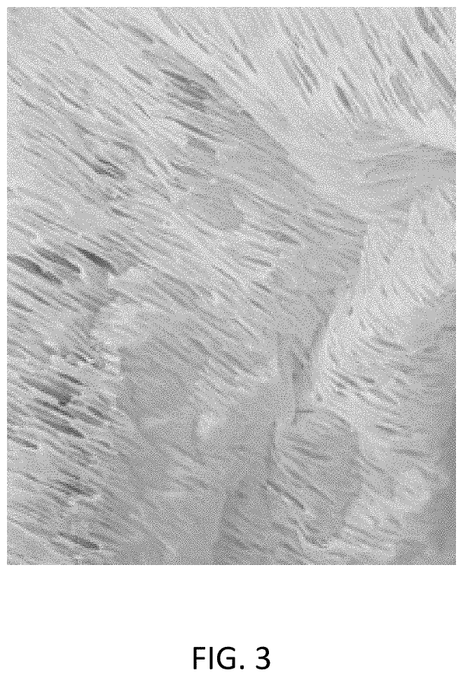

In specific embodiments, step (c) of forming the thin film packaging material further comprises the inclusion of foaming agents for forming micropores and or channels within at least one layer of the multi-layered thin film, to generate a foamed film structure. FIG. 3 depicts a close up of packaging in accordance with one aspect of the invention. The foam structure is apparent in the packaging.

Suitable foaming agents include, but are not limited to, CO₂ emitters such as citric acid/sodium bicarbonate preparations or N₂ emitters such as azodicarbonate, or H₂ emitters such as sodium borohydride. Accordingly, in a specific embodiment of the packaging material of the invention, the removal of the water from within the package is enabled by a physical structure of the plastic mass that ensures accessibility of water and water vapor to the hygroscopic material embedded in the packaging film. Foaming agents are generally added in amounts of 0.05 to 5 wt. %, for example, 0.5 to 1.5 wt. %, per layer.

In some embodiments, an anti-block may combined with the polymer layers, typically the inner and/or outer layers. Suitable anti-blocks may be inorganic or organic and include, but are not limited to silica, talc, calcium carbonate, kaolin, mica, amides, and stearates. Anti-blocks may be added in any suitable amount, for example, 0 to 10%, such as 0.1 to 1% in the outer layer or 7 to 9% in the inner layer.

In some embodiments, an antioxidant may combined with the polymer layers, typically the inner and/or core layers. Suitable antioxidants may be free-radical scavengers such as hindered phenols and secondary aromatic amines. Antioxidants may be added in any suitable amount, for example, 0 to 2%, such as 0.1 to 1.2% per layer.

In some embodiments, a lubricant may combined with the polymer layers. Suitable lubricants may include, but are not limited to amides, acid esters, fatty acids, and the like.

In some embodiments a sulfate or sulfur oxide is added as a preservative, for example on amounts of up to 8%, typically about 5%, per layer.

Typically an outer layer is composed of one or more polymers, for example 100% LDPE; or a combination of LLDPE, MDPE, and anti-block such as 75 to 80% LLDPE, 20 to 25% MDPE, and 0.5% anti-block.

A core or middle layer may be a combination of one or more polymers such as EVA and LLDPE, a foaming agent, and hygroscopic material. For example, 93 to 98% EVA, 0.5 to 1.5% foaming agent, and 2 to 5% NaCl; or 65 to 70% EVA desiccant, 25 to 30% LLDPE, 0.5% foaming agent, and optionally 5% sulfur oxide.

The inner layer (that would be placed adjacent the produce, may be composed on one or more polymers such as LDPE and EVA, and a foaming agent and/or a hygroscopic material. For example, the inner layer may be 100% LDPE; or a combination of, for example, 85 to 95% EVA, 1 to 2.5% foaming agent, 1% antioxidant, and 5 to 10% NaCl; or a combination of 58 to 63% EVA desiccant, 25 to 30% LDPE, 1% antioxidant, 0.5% foaming agent, and optionally 5% sulfur oxide.

The EVA desiccant may be a combination of LLDPE, EVA, and hygroscopic material. The hygroscopic material may be composed of sodium chloride, Ca, Mg, and/or SO₄, for example, 90 to 98 wt. % NaCl, 0.5 to 1.5 wt. % H₂O, 0.55 to 1.5 wt. % Ca, 0.2-2.0 wt. % Mg, and/or 0.5-5.0 wt. % SO₄.

The layer thickness ratio of the outer layer : core layer: inner layer may be 10%-30%:50% 80%:10%-30%, for example 1-1.5:1:1.

The hygroscopic material includes at least one salt. The salts absorb water (vapor and/or liquid). The salts may form a saturated solution by a mechanism known as deliquescence, a process by which a substance absorbs moisture from the environment until it dissolves in the absorbed water and forms a solution. Deliquescence occurs when the vapor pressure of the solution that is formed is less than the partial pressure of water vapor in the air. Hence, when this process occurs within the plastic mass of the package film of the invention at the spots where salt particles are located, the plastic film may become wet by minute amounts of salt solution thereby supporting the preservation effects of the packaging material of the invention.

In certain embodiments, the present invention provides an efficient, cost effective, and low cost hygroscopic-containing packaging materials and method of their formulation for delaying foodstuff deterioration.

In addition, in certain embodiments, the present invention provides food packages comprising a thin film layer comprising the hygroscopic material designed to maintain a balance of water vapors from the food packed therein and from the inner space of the package.

Certain embodiments of the invention will now be further illustrated by the following non-limiting examples and experiments.

### EXAMPLE 1

### Materials/Preparation of Film

The following were used to form a multilayer film:

Low density polyethylene (LDPE) 320 IPETHENE® 320 from “Carmel Olefins” (Haifa, Israel) having Melt Flow Rate (MFR) of 2 g/10 min (190° C./2.16 Kg) and density of 0.92 g/cm³;

Ethylene vinyl acetate copolymer (EVA), GreenFlex FF55 (19% vinyl acetate content) from “Polimeri Europa” (Roma, Italy) having Melt Flow Index (MFI) of 0.7 g/10 min (190° C./2.16 Kg) and density of 0.94 g/cm³.

Hygroscopic salt, NaCl, supplied by Salt of The Earth Ltd. (Atlit, Israel) and ground in a jet mill, into a fine powder having an average major axis diameter of 2 μm.

Foaming agent (FA), TRACEL PO 2201, supplied from Tramaco, Germany.

In addition, agarose (low gelling temperature—BioReagent, soluble 10 mg/mL (with heat)) was used as a food simulant for the moisture absorbance measurements and was purchased from sigma Aldrich (Munich, Germany).

Masterbatch compounds were produced by melt blending in an APV Baker Inc. twin screw co-rotating extruder (D=25 mm, L/D=50), at a temperature range of 145° C.-210° C. and screw speed of 240 rpm. The foaming and hygroscopic agents were introduced into the EVA polymer at 4% and 18% by weight, respectively. The masterbatch was diluted with neat EVA to obtain the desired compounds for the film blowing process. The final compositions of the prepared materials are given in Table 1 below.

Three-layered thermoplastic film blowing was performed using a laboratory film blowing co-extruder (Betol Machinery Ltd.) with a die diameter of 100 mm, a die gap of 1 mm, and a film diameter of 190 mm. The film blowing was operated with a temperature profile from 150° C. to 170° C. from feeding zone to die, respectively, in all three extruders. Films with a final thickness of 80 to 250 μm were produced. The final compositions of the prepared films are given in Table 1 below.

TABLE 1
Composition of prepared films (wt. %)

| | | | | | Film | |
|---|---|---|---|---|---|---|
| Film | Outer | | Inner | layers | thickness | Total % |
| composition | layer | Core | layer | ratios | [μ] | of NaCl |
| Reference | LDPE 100% | LDPE 100% | LDPE 100% | 1:1:1 | 120 | 0 |
| film | | | | | | |
| Film 1 | LDPE 100% | EVA 92.7% + | EVA 95.6% + | 1.5:1:1 | 250 | 2.74 |
| | | FA 1.3% + | FA 0.8% + | | | |
| | | NaCl 6% | NaCl 3.6% | | | |
| Film 2 | LDPE 100% | EVA 89% + | LDPE 100% | 1:1:1 | 150 | 3 |
| | | FA 2% + | | | | |
| | | NaCl 9% | | | | |

### EXAMPLE 2

### Moisture Absorption Over Time

NaCl was used as a humidity regulating agent at different percentages. NaCl was incorporated into the three-layered thermoplastic active films as described in Table 1. Agarose (100 g) was packed in control glass jars (230 ml). The produced films (40.7 cm²) were sealed on top of the glass jars with inner layer facing down and placed for 10-14 days at 3-4° C. The amount of relative humidity in the jars headspace was monitored over time using a relative humidity logger (TMI Barak—Technological Measurement Instruments.) The amount of moisture absorbed by the films during storage was gravimetrically determined by measuring increase in weight of the films.

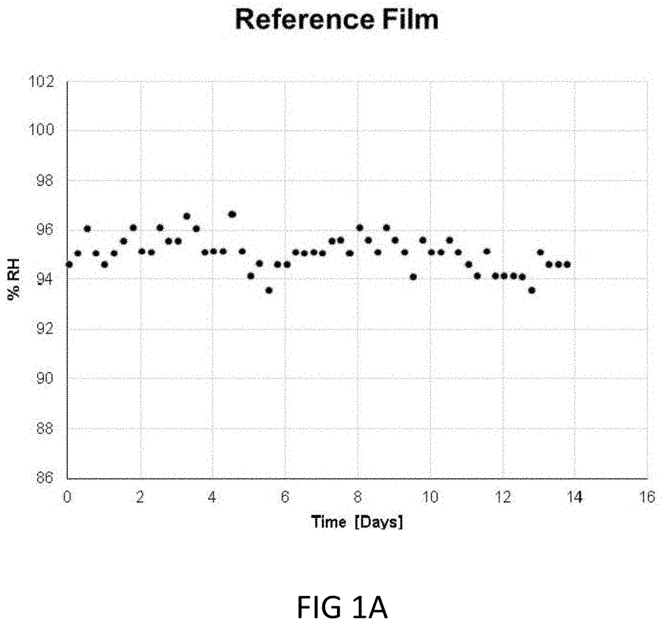

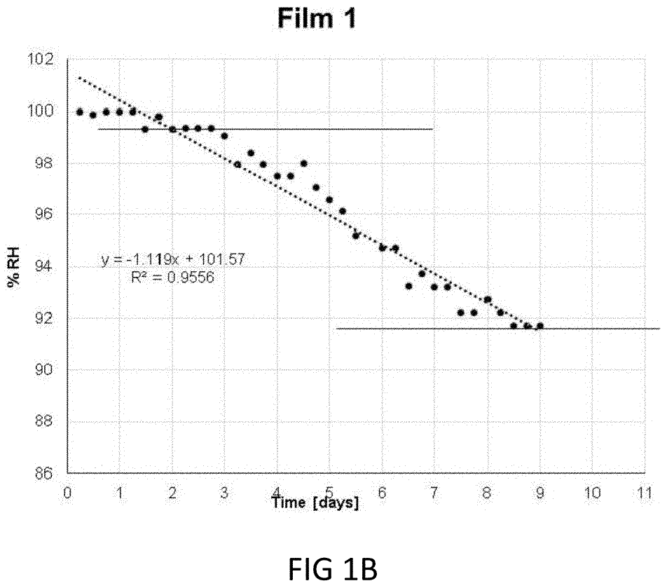

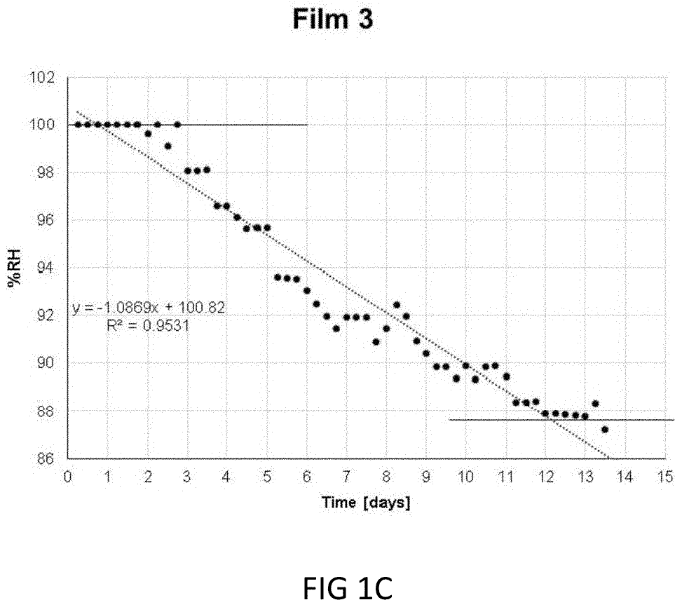

FIGS. 1A-1C are graphs showing water vapor (WV) absorption from a space enclosed by the following film compositions: (FIG. 1A) control films without any hygroscopic material; (FIG. 1B) films containing 2.8% w/w NaCl; The film is a three layered coextruded film, 250 μm thick and the salt was included in the asterisks marked layers as follows: A*/B*/C; and (FIG. 1C) films containing 3% w/w NaCl. The film is a three layered coextruded film, 150 μm thick and the salt was included in the asterisks marked layers as follows: A/B*/C. All of the films contained foaming agents. The difference in the results was due to different structure of the films layers and concentrations of the additives.

### EXAMPLE 3

### Storage Trial

Trials were conducted at the Yair Experiments Station at Moshav Faran using green peppers. Storage boxes were lined with 80 μm thick, 50×60 cm bags, each one with 5 Kg produce. Plastic bags were treated with a compounded mixture of NaCl and Ca.

Table 2 below indicates superior performance of 3871 bags over standard plastic bags or no bag, even at higher moisture scale. Similar results were obtained in all repeated experiments.

TABLE 2

| Moisture | Rotten | Molded | Molded | Days of storage | | Pre- |
|---|---|---|---|---|---|---|
| scale 0-5 | fruits % | fruits % | stems % | at 4° C. | Bag # | disinfection |
| 2 | 40 | 0 | 10 | 21 | 3707* | water-Cl |
| 4 | 10 | 0 | 5 | 21 | 3871* | water-Cl |
| 4 | 30 | 10 | 0 | 21 | 3873* | water-Cl |
| 1 | 45 | 10 | 5 | 21 | Stepack | water-Cl |
| 1 | 35 | 5 | 5 | 21 | Stepack | water |
| 0 | 31 | 5 | 21 | 21 | No bag | water |
| 0 | 30 | 0 | 15 | 21 | No bag | water-Cl |

*PlastoSac anti-spoilage packaging

### EXAMPLE 4

### Film Moisture Absorbance in Moist Environment

Moisture absorbance on contact with a food simulator (agar gels) was determined by measuring the increase in film weight. Film samples prepared according to the invention were placed in direct contact with agar gels and kept in refrigerated conditions for 10 days. Results showed an increase in film weight of about 95-120%.

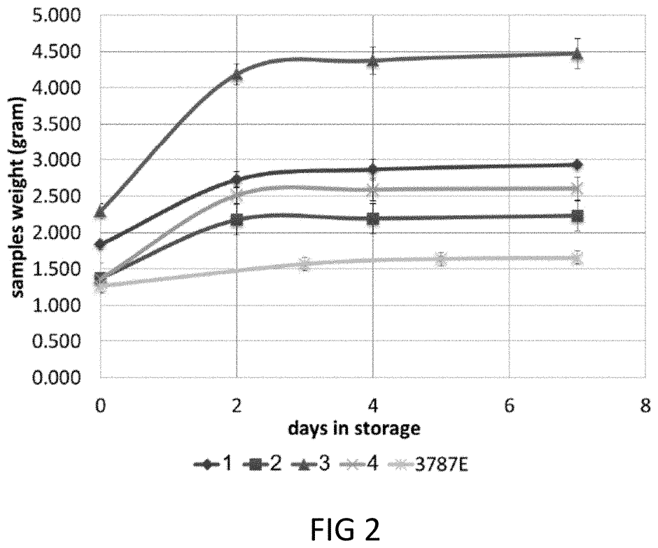

FIG. 2 presents one exemplary experiment in which absorbance of the film samples was determined by following the changes in film samples' weight while stored in an acclimatization chamber at 98% RH and 38° C. During first two days, all the films absorbed humidity until saturation was reached and then started to create an environment inhibiting growth of molds.

### EXAMPLE 5

Sample film A was prepared in accordance with the following:

| Active Ingredients | Layer A | Layer B | Layer C |
|---|---|---|---|
| Anti-Block - Masterbatch (“MB”) | 0.5% | | 8.0% |
| Antioxidant MB | | 1.0% | 1.0% |
| EVA Desiccant 00K97 MB * | | 68.5% | 60.5% |
| Low Density Poly Ethylene (LDPE) | | | 30.0% |
| Linear LDPE (LLDPE) | 77.5% | 30.0% | |
| Foaming agent MB | | 0.5% | 0.5% |
| Medium Density Poly Ethylene (MDPE) | 22.0% | | |

Sample film B was prepared in accordance with the following:

| Active Ingredients | Layer A | Layer B | Layer C |
|---|---|---|---|
| Anti-Block MB | 0.5% | | 8.0% |
| Antioxidant MB | | 1.0% | 1.0% |
| EVA Desiccant 00K97 MB * | | 68.5% | 60.5% |
| Low Density Poly Ethylene (LDPE) | | | 25.0% |
| Linear LDPE (LLDPE) | 77.5% | 25.0% | |
| Foaming agent MB | | 0.5% | 0.5% |
| Medium Density Poly Ethylene (MDPE) | 22.0% | | |
| Sulfur Oxide MB (SO) | | 5.0% | 5.0% |

* EVA Desiccant 00K97 MB contained 15.0% LLDPE, 67.0% ethyl vinyl acetate (EVA), and 18.0% sodium chloride C**.

**Sodium chloride C contained:

| | |
|---|---|
| NaCl | 90.00%-98.0% |
| H₂O | 0.5%-1.5% |
| Ca | 0.55%-1.5% |
| Mg | 0.2%-2.0% |
| SO₄ | 0.5%-5.0% |

The packaging films may be used as a film, as a liner bag, as a foamed pad, or as a laminated film or sheet. Importantly, the film contains a micronized active ingredient (hygroscopic agent) either incorporated into the film or coated on the surface of the film.

The packaging films of the present invention may be used alone or in combination with other packaging to form packaging units, such as a cardboard box or container containing produce enclosed in packaging bags or films of the present invention. Fresh fruits and/or vegetable are harvested shortly before packed in packaging unit. The produce is stored and shipped. Packing produce in packaging units allows for a reduction of evaporation rate of water vapor from the packaged contents, creation of an environment that inhibits the development of mold and rot, maintaining the solidity and the appearance of the fruit/vegetable, improving resistance against “mechanical” damage (e.g. crushing) during transport, and preservation of taste and sugar levels during the storage period.

Ideally, the produce is packed into packaging units after initial cooling of not less than 0° C. compared to the temperature at the harvest stage. The produce is sorted and cleaned prior to packaging into the packing unit box, to prevent, as much as possible, the presences of damaged or infected fruit. The packaging units containing produce should be stored in a cooled environment, at the lowest degree of cold that can be obtained, without harming the packaged produce. The packed produce should be in contact with the surface of the plastic sheet in order to allow for maximal contact of the water vapor (leaving the fruit/vegetable) with the active ingredient. The binding of the water vapor to the active substance creates the “delay-effect” of mold development and the decay of the produce.

The present invention is applicable to a wide range of fruits & vegetables such as, but not limited to bell papers, pomegranate, strawberries, eggplant, figs, sweet potatoes, radishes, carrots, basil and chives. Results from various produce are shown in the table below:

| | Current | Inventive | | Storage and | |
|---|---|---|---|---|---|
| Produce | Packaging | Packaging | Advantage | Transport time | |
| Figs | Bare, in carton, | In carton with | Extension of storage | 16 | days |
| | on supported | nest pack in | and transport time | | |
| | tray (Nes-Pack) | inventive liner | from 6 days to 16 | | |
| | | | days | | |
| Sweet Potatoes | Bare, In carton | In carton in | Significant | 3 | weeks |
| | | inventive liner | improvement in quality | | |
| | | | and appearance | | |
| Red Table | In carton, in bag | In carton in | Significant | 4 | weeks |
| Grapes | with PE bag + | inventive liner | improvement in Firmness | | |
| | Sulfur pads | only | and Appearance | | |
| Pomegranates | Bare, In carton | In carton in | Saving of 14% in | 2 | Months |
| | | inventive liner | weight, significant | | |
| | | | improvement of appearance | | |
| | | | and quality | | |
| Basil | In carton, with | In carton in | Extension of Storage | 11 | days |
| | PE Bag | inventive liner | and Transport time from | | |
| | | | a week to 11 day, | | |
| | | | improvement of Quality | | |
| | | | and appearance | | |

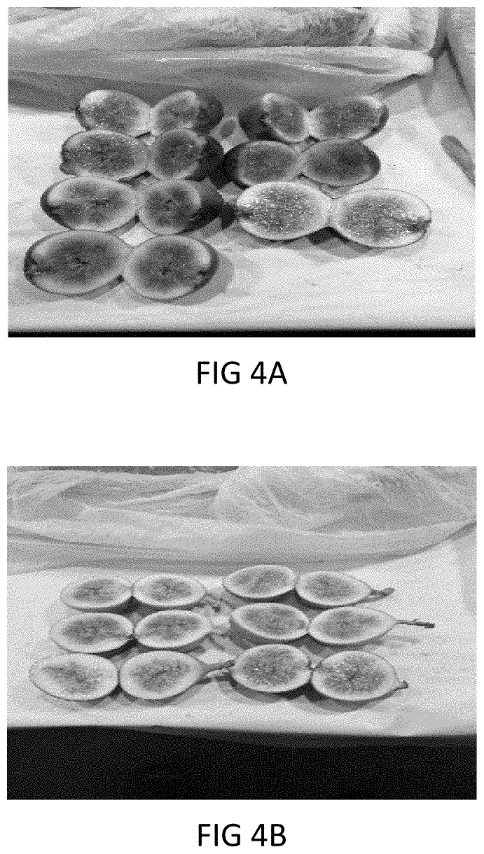

FIGS. 4A and 4B show figs after 16 days of storage and transport. FIG. 4A shows figs stored in a package in a conventional box and FIG. 4B shows figs stored in a package in accordance with the present invention. It is easily seen that the figs stored in accordance with packaging of the present invention were much better preserved than figs stored in a conventional manner. The package in accordance with the present invention extended storage time from 6 to 16 days.

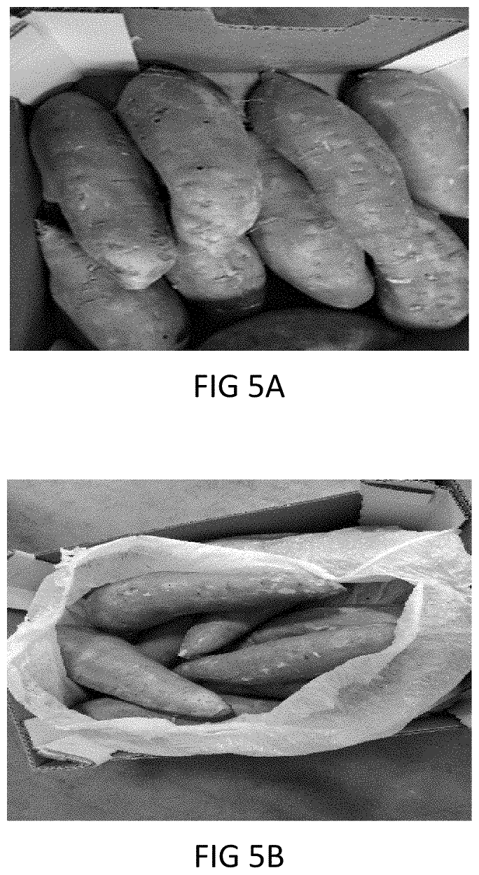

FIGS. 5A and 5B show sweet potatoes after 3 weeks storage and transport. FIG. 5A shows sweet potatoes stored in a conventional box and FIG. 5B shows sweet potatoes stored in a package in accordance with the present invention. It is easily seen that the sweet potatoes stored in accordance with packaging of the present invention were much better preserved than sweet potatoes stored in a conventional manner. The package in accordance with the present invention kept the humidity level similar to the potatoes in the ground, maintaining its initial red color of the sweet potatoes.

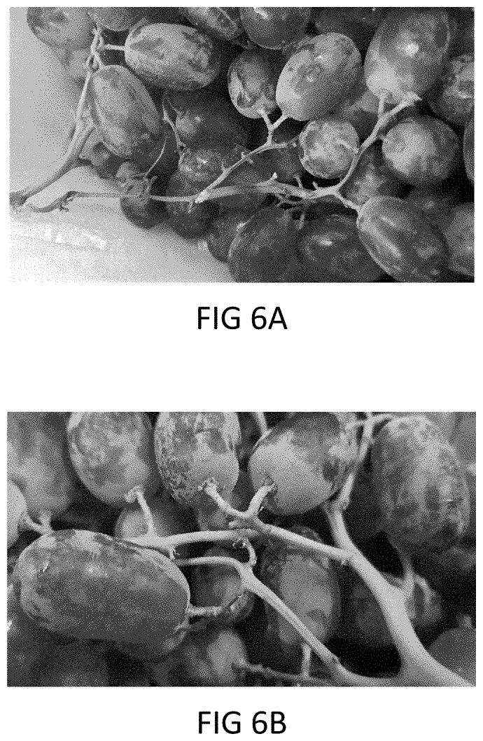

FIGS. 6A and 6B show red table grapes after 4 weeks storage and transport. FIG. 6A shows grapes stored in a conventional box and FIG. 5B shows grapes stored in a package in accordance with the present invention. The grapes stored in accordance with packaging of the present invention were much better preserved than grapes stored in a conventional manner.

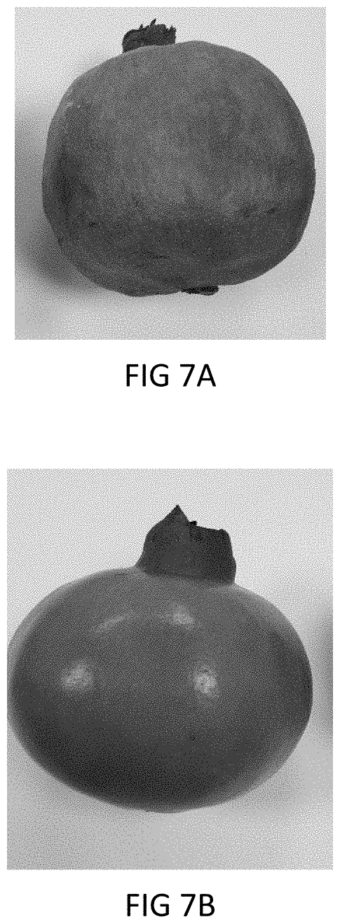

FIGS. 7A and 7B show pomegranates after 2 months storage and transport. FIG. 7A shows pomegranates stored in a conventional box and FIG. 7B shows pomegranates stored in a package in accordance with the present invention. It is easily seen that the pomegranates stored in accordance with packaging of the present invention were much better preserved than pomegranates stored in a conventional manner.

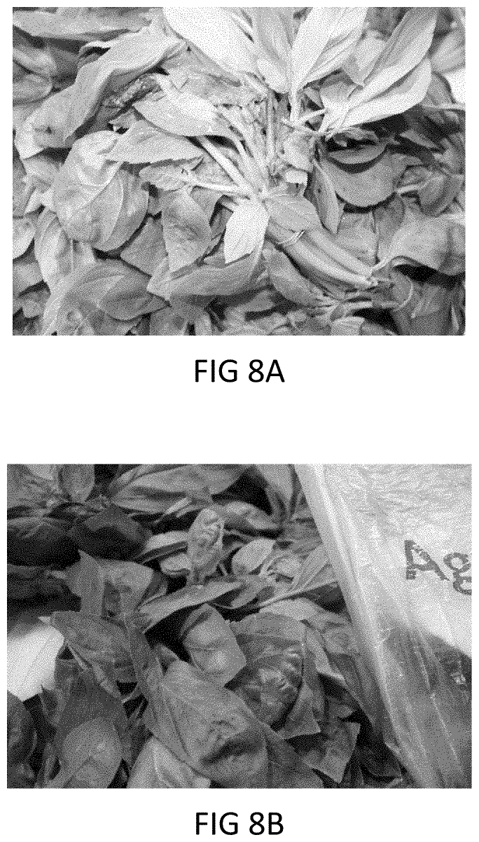

FIGS. 8A and 8B show basil after 11 days storage and transport. FIG. 8A shows basil stored in a conventional box and FIG. 7B shows basil stored in a package in accordance with the present invention. It is easily seen that the basil stored in accordance with packaging of the present invention were much better preserved than basil stored in a conventional manner.

### EXAMPLE 6

A Plastosac film contained a compounded mixture of NaCl, Ca, Mg, and SO₄.

The Plastosac film was kept in 100% humidity. After 24 hours film was wet. The wet film changed its appearance from transparent to opaque (white). The film sample was rinsed with deionized water. The sodium chloride was rinsed from surface of the wet film and transferred into the water. A dry non-treated film was rinsed with deionized water. The two water samples were tested for the presence of chloride ions by Mohr titration with AgNO₃ with addition of potassium chromate for end point determination. Titration showed the presence of chloride ions in the wet sample and absence of chloride ions in the dry film. The wet films contain 4.6×10⁴ mmol of sodium chloride per cm², or 0.025 mg/cm².

A cucumber was put into package prepared from Plastosac film and closed (hermetically) by another plastic bag. Such prepared sample was put into a cold place for one week. Another cucumber was put into the plastic bag and also was kept in the cold place for one week. After one week, the cucumbers were rinsed by deionized water. The water samples were titrated by Mohr's reagents (as above). The sample contained in the Plastosac film package showed the presence of chloride ions. The concentration of chloride ions was 2.6 mg/cucumber. The evaluated skin surface of cucumber was 180 cm², therefore, the sodium chloride concentration is 0.015 mg/cm².

Cucumber is low storage natural product. In general, 7-14 days is a maximum period of storage even in low temperature (10° C.). Cucumbers will soften by water loss, chlorophyll degradation, fungus activity (Mukos), lipids (phospholipids) degradation by enzymes (e.g. phospholipase,) and microbe activity that is present in the environment.

Plastosac film provides for a source of water vapors in packaged cucumbers. The presence of water vapors will have tendency to form dilute sodium chloride solution on the films inner surface. The presence of pores in the film increases the diffusion delivery of water vapors from the environment to sodium chloride. The surface tension of sodium chloride solution is very high (more than 72 Dyn/cm). Therefore, it will withdraw from the inner parts of film onto its surface.

When the surface of film was not in contact with cucumber, aqueous solution formed drops on the film surface (the film surface is very hydroscopic). Due to the non-horizontal type of surface, aqueous drops moved on the surface, formed bigger drops and finally fell on the cucumber surface. The presence of salt solution on the film prevented activity of environmental microbes.

When the surface of the film contacted the cucumber skin, aqueous salt solution moved from the inside part of film onto cucumber skin directly and formed drops, thin film etc. (Cucumber skin is more hydrophobic then Plastosac film). The presence of salt on the cucumber skin lowered the fungi's activity and therefore, prevented softening. There is also possibility to decrease the enzymatic activity of phospholipase by sodium ions.

Thus Plastosac film prevents softening of cucumbers by presenting environmental microbial activity by salt solution, preventing fungi activity, decreasing enzymatic activity of phospholipase, and preventing water loss by wrapping the cucumbers into plastic film. In addition, the packaging preserved the weight and avoided blackening of produce surface/skin of radishes, preserved the weight and avoided browning of carrots, preserved the weight of bell peppers, extended storage time by two weeks of strawberries while maintaining and conserving original quality, and maintained weight and condition of chives while extending storage to at least 10 days.

The invention has been described with respect to specific examples including various aspects of the invention. Those skilled in the art will appreciate that there are numerous variations and permutations of the above described systems and techniques. Thus, the spirit and scope of the invention should be construed broadly as set forth in the appended claims.

1. An anti-spoilage packaging material comprising
a film comprising one or more layers;
hygroscopic material embedded within at least one of the one or more layers;
wherein the hygroscopic material comprises a salt, SO₄, and at least one of magnesium and calcium;
wherein the hygroscopic material has an average particle size of 25 μm or less and is present in the one or more layers in amount from 1 wt. % to 20 wt. %; and
wherein the packaging material maintains an equilibrium relative humidity (ERH) of packed goods between 95% and 100%.

2. The packaging material of claim 1, wherein the average particle size is 20 μm or less.

3. The packaging material of claim 1, wherein at least one layer of the one or more layers comprises a foaming agent.

4. The packaging material of claim 1 wherein at least one of the one or more layers comprises micro-pores, wherein the micro-pores are sufficiently large to allow access of water molecules within the packaging material to the hygroscopic material embedded in the at least one of the one or more layers.

5. The packaging material of claim 1, wherein the film comprises at least one polymer selected from ethylene vinyl acetate, low density polyethylene, linear low density polyethylene, and medium density polyethylene.

6. The packaging material of claim 1, wherein the film further comprises at least one selected from anti-block agents, antioxidants, lubricants, and preservatives.

7. The packaging material of claim 1, further comprising a preservative amount of sulfur oxide.

8. The packaging material of claim 1, wherein the salt is sodium chloride (NaCl).

9. The packaging material of claim 1, wherein the packaging material maintains the equilibrium relative humidity (ERH) of packed goods by 98% to 100%.

10. The packaging material of claim 1, wherein the hygroscopic material in the one or more layers is present in an amount from 1 wt. % to 18 wt. %.

11. The packaging material of claim 1, wherein the film comprises an outer layer, a core layer, and an inner layer; and wherein layer and inner layer each comprise the hygroscopic material.

12. The packaging material of claim 11 wherein the outer layer comprises 100% low density polyethylene or a combination of linear low density polyethylene and medium density polyethylene.

13. The packaging material of claim 11 wherein the core layer comprises ethylene vinyl acetate, foaming agent, and hygroscopic agent; or ethylene vinyl acetate, linear low density polyethylene, foaming agent, and hygroscopic agent.

14. The packaging material of claim 11 wherein the inner layer comprises low density polyethylene and ethylene vinyl acetate, foaming agent, and hygroscopic agent.

15. A packaging material of comprising at least three layers, the at least three layers comprising:
an outer layer comprising at least one selected from low density polyethylene, linear low density polyethylene, and medium density polyethylene;
a core layer comprising ethylene vinyl acetate, at least one foaming agent, at least one hygroscopic material, and optionally linear low density;
an inner layer comprising low density polyethylene, low density polyethylene, foaming agent, and hygroscopic material;
wherein the hygroscopic material comprises salt and at least one additive selected from magnesium, calcium, and a preservative;
wherein the hygroscopic material has an average particle size of 25 μm or less and is present in the one or more layers in amount from 1 wt. % to 20 wt. %; and
wherein the packaging material maintains an equilibrium relative humidity (ERH) of packed goods between 95% and 100%.

16. The packaging material of claim 15 wherein the preservative is sulfur oxide.

17. A method for preparation of a thin film packaging material comprising at least one polymer layer and hygroscopic material embedded within at least one of the at least one polymer layers, the method comprising the steps of:
c) grinding the hygroscopic material to a particle size of 25 μm or less;
d) mixing the ground hygroscopic material with one or more polymers; and
e) forming the thin film packaging material, wherein the thin film packaging material maintains an equilibrium relative humidity (ERH) of packed goods between 95% and 100%.

18. The method of claim 17, wherein prior to step c), adding at least one foaming agent to the hygroscopic material, and forming a micro-pore structure during formation of the thin film packaging material.

19. The method of claim 17, wherein the thin film packaging material comprises multiple layers and the hygroscopic material are embedded in at least one of the layers.

20. The method of claim 17, wherein the thin film packaging material maintains an equilibrium relative humidity (ERH) of packed goods between 98% and 100%.

21. The method of claim 17, wherein the thin film packaging material comprises:
an outer layer comprising at least one selected from low density polyethylene, linear low density polyethylene, and medium density polyethylene;
a core layer comprising ethylene vinyl acetate, at least one foaming agent, at least one hygroscopic agent, and optionally linear low density; and
an inner layer comprising low density polyethylene, low density polyethylene, foaming agent, and hygroscopic agent;
wherein at least one of the inner layer and core layer comprises a preservative.
